(19) United States
(12) Patent Application Publication
(10) Pub. No.: US 2026/0292955 A1
(43) Pub. Date: Sep. 24, 2026

(54) STAND MIXER BOWL LIGHT AND TILT SENSING

(71) Applicant: WHIRLPOOL CORPORATION, BENTON HARBOR, MI (US)

(72) Inventors: Joseph William Adams, Baroda, MI (US); Natalie Brooke Hodge, Novi, MI (US); Hrishikesh Sudhakar Kakade, Pune (IN); Sheetal Krishen Pandita, Pune (IN); Poonam Prabhakar Pawar, Pune (IN); Liying Peng, St. Joseph, MI (US); Siddharthkumar Rohitbhai Rana, Bilimora (IN); Joseph Edward Rendzikowski, St. Joseph, MI (US)

(73) Assignee: WHIRLPOOL CORPORATION, BENTON HARBOR, MI (US)

(21) Appl. No.: 19/085,751

(22) Filed: Mar. 20, 2025

(51) Int. Cl. H05B 47/105; A47J 43/044; A47J 43/07; H05B 45/10; H05B 47/16; H05B 47/17

(52) U.S. Cl. CPC H05B 47/105; A47J 43/0705; H05B 45/10; H05B 47/16; H05B 47/17; A47J 2043/04481

(57) ABSTRACT

A stand mixer includes a body and a mixer head pivotably coupled with the body and configured to pivot between an open position and a closed position relative to the body. An attachment portion is coupled to a bottom side of the mixer head and a light source is interposed at the bottom side between the body and the attachment portion. An angular sensor and a timer are disposed within an interior of the mixer head. A controller is in communication with the angular sensor, the timer, and the light source and configured to control the light source in response to sensor data produced by the angular sensor in conjunction with timing data produced by the timer.

### BACKGROUND OF THE DISCLOSURE

The present disclosure generally relates to a stand mixer, and more specifically, to a stand mixer with a light source controlled by a controller to emit light in accordance with a variety of operational conditions of the stand mixer.

### SUMMARY OF THE DISCLOSURE

According to one aspect of the present disclosure, a stand mixer includes a body and a mixer head pivotably coupled to the body and configured to pivot between an open position and a closed position. An attachment portion is coupled to a bottom side of the mixer head. An angular sensor is coupled with the mixer head and configured to produce sensor data indicative of the angular position of the mixer head relative to the body. A light source is coupled with the bottom side of the mixer head and interposed between the body and the attachment portion. A controller is in communication with the angular sensor and the light source and configured to control the light source in response to the sensor data produced by the angular sensor.

According to another aspect of the present disclosure, a stand mixer includes a body and a mixer head pivotably coupled to the body. An attachment portion is coupled to a bottom side of the mixer head. A sensor is coupled with a bottom side of the mixer head. A light source is coupled with the bottom side of the mixer head and interposed between the body and the attachment portion. A controller is in communication with the sensor and the light source. The controller controls the light source in response to sensor data produced by the sensor.

According to yet another aspect of the present disclosure, a stand mixer includes a body and a mixer head pivotably coupled to the body. An attachment portion is coupled to a bottom side of the mixer head. A mixing attachment is coupled with the attachment portion. A speed slider is operably coupled with the mixer head and is configured to be operable by a user to control a rotational velocity of the mixing attachment. A mode selector is operably coupled with the mixer head and is configured to be operable by a user to select an operational mode of the stand mixer. An angular sensor is operably coupled with the mixer head and is configured to produce sensor data indicative of the angular position of the mixer head relative to the body. A timer is operably coupled with the mixer head. A light source is operably coupled with the bottom side of the mixer head and interposed between the body and the attachment portion. A controller is in communication with the speed slider, the mode selector, the angular sensor, the timer, and the light source. The controller is configured to control the light source in response to the sensor data produced by the angular sensor.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side elevational view of the stand mixer showing a partial view of an interior of a mixer head of the stand mixer.

FIG. 2 is a side elevational view of the stand mixer.

FIG. 3 is a side elevational view of the stand mixer.

FIG. 4A is a top perspective view of the stand mixer in an open position.

FIG. 4B is a top perspective view of the stand mixer in a closed position.

FIG. 5 is a top perspective exploded view of an electronic assembly of the stand mixer separated from a support member.

FIG. 6 is a bottom perspective view of the electronic assembly coupled with the support member.

FIG. 7 is a top perspective exploded view illustrating the interior of the mixer head and the alignment of the electronic assembly within the interior of the mixer head.

FIG. 8 is a bottom plan view of the mixer head showing the position of a light aperture.

FIG. 9 is a partial cross-sectional view of the mixer head taken at lines IX in FIG. 4B, showing the position of the electronic assembly within the interior of the mixer head.

FIG. 10 is an enlarged detailed view of area X in FIG. 9, showing a lens partially disposed within the light aperture.

FIG. 11 is a top perspective view of a top side of the lens.

FIG. 12 is a top perspective view of the electronic assembly coupled with the support member, showing the interaction between a speed slider and a mode selector and the electronic assembly.

FIG. 13 is a schematic illustrating the interactions between various components of the electronic assembly.

The components in the figures are not necessarily to scale, emphasis instead being placed upon illustrating the principles described herein.

### DETAILED DESCRIPTION

The present illustrated embodiments reside primarily in combinations of method steps and apparatus components related to a stand mixer with a light source controlled by a controller to emit light in accordance with a variety of operational conditions of the stand mixer. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

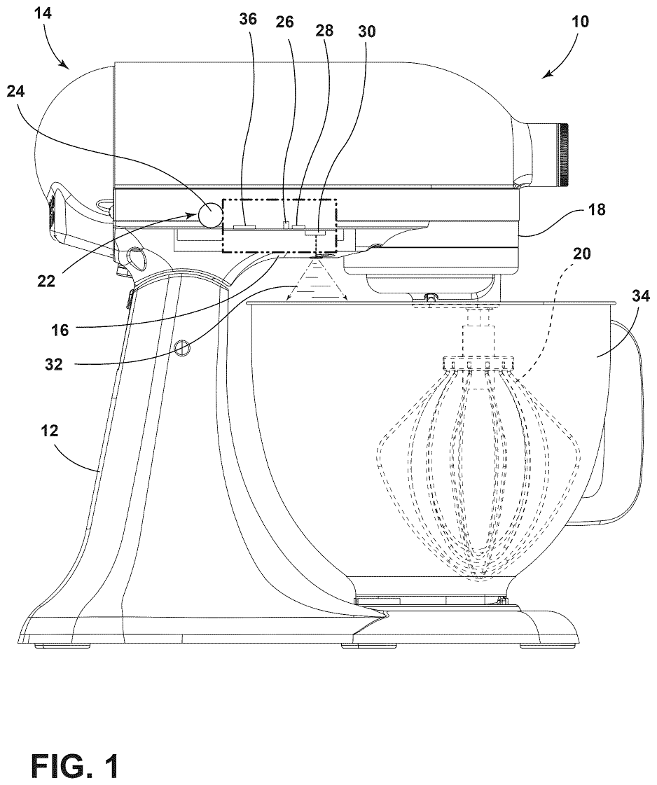

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

Referring to FIGS. 1-13, reference numeral 10 generally designates a countertop stand mixer appliance 10 (hereinafter “stand mixer”). The stand mixer 10 may include a body 12 and a mixer head 14 that is pivotably coupled to the body 12. The mixer head 14 may form a bottom side 16. An attachment portion 18 may be coupled to the bottom side 16 of the mixer head 14. A mixing attachment 20 may be coupled with the attachment portion 18. A speed slider 22 may be coupled with the mixer head 14 and configured to be operable by a user of the stand mixer 10 to control the rotational velocity of the mixing attachment 20. A mode selector 24 may be coupled with the mixer head 14 and configured to be operable by the user to select an operational mode of the stand mixer 10. An angular sensor 26 may be coupled with the mixer head 14 and configured to produce sensor data indicative of the angular position of the mixer head 14 relative to the body 12. A timer 28 may be coupled with the mixer head 14 and configured to produce timing data. A light source 30 may be coupled with the bottom side 16 of the mixer head 14 and interposed between the body 12 and the attachment portion 18. The light source 30 may be configured to emit light 32 substantially in the direction of a mixing bowl 34. A controller 36 may be coupled with the mixer head 14 and may be in communication with the speed slider 22, the mode selector 24, the angular sensor 26, the timer 28, and the light source 30. The controller 36 may be configured to control the light source 30 in response to the sensor data produced by the angular sensor 26.

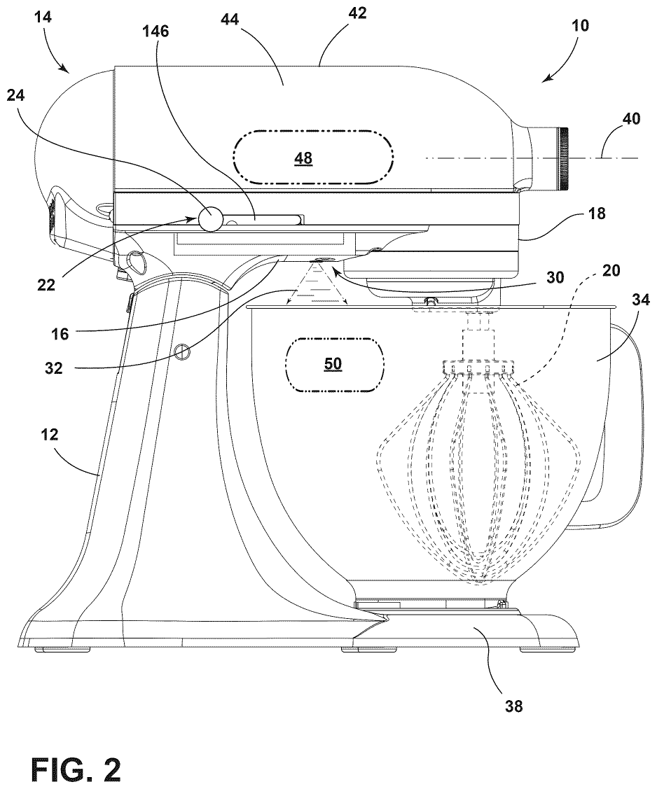

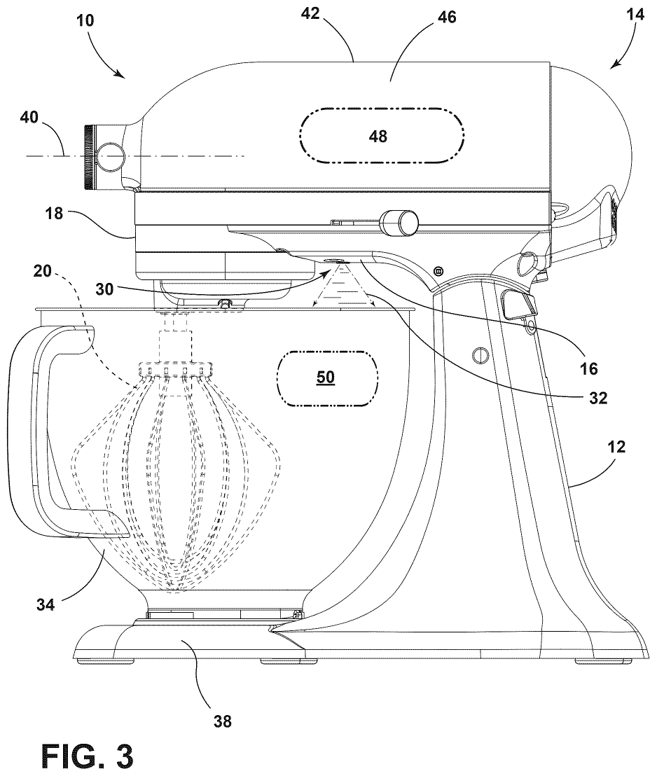

Referring now to FIGS. 2 and 3, the body 12 of the illustrated stand mixer 10 extends vertically from a base 38 that provides support for the stand mixer 10. The mixer head 14 extends laterally from the body 12 and defines a lateral axis 40. The mixer head 14 is formed by the bottom side 16 and a top side 42 opposite the bottom side 16. Additionally, the mixer head 14 is formed by a first side wall 44 and a second side wall 46 opposite the first side wall 44. Both the first side wall 44 and the second side wall 46 extend between and connect the top side 42 and the bottom side 16. Accordingly, the bottom side 16, the top side 42, the first side wall 44, and the second side wall 46 cooperate to define a hollow interior 48 of the mixer head 14. The attachment portion 18 is coupled to the bottom side 16 and may be positioned at a distal portion of the bottom side 16 relative to the body 12. The mixing attachment 20 is detachably coupled with and may vertically extend from the attachment portion 18. The mixing attachment 20 may be received within an interior 50 of the mixing bowl 34 that may be detachably coupled with the base 38.

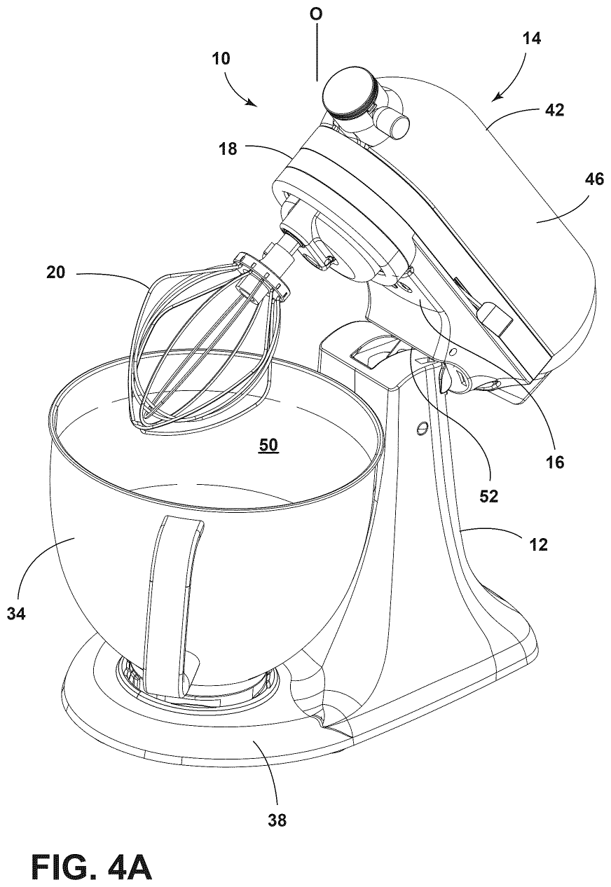

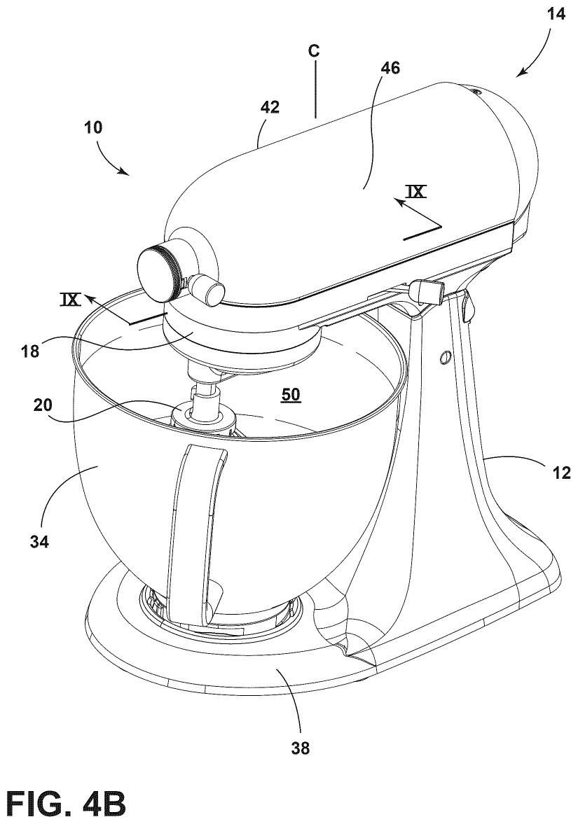

Referring to FIGS. 4A and 4B, the stand mixer 10 is a tilt-head stand mixer 10, and as such, the mixer head 14 is configured to pivot between an open position O (FIG. 4A) and a closed position C (FIG. 4B) relative to the body 12 about a pivot point 52. In various examples, the stand mixer 10 or the mixer head 14 are referred to as being in the open position O or the closed position C. For example, the stand mixer 10 may be in the open position O when the mixer head 14 is rotated upward at an angle of between approximately 45° and approximately 60° relative to the body 12. Alternatively, the mixer head 14 may be rotated downwards at an angle of approximately 0° and approximately 10° relative to the body 12. In the closed position C, the mixing attachment 20 may be received within the interior 50 of the mixing bowl 34 allowing for baking constituents within the mixing bowl 34 to be mixed. Additionally, as the mixer head 14 travels between the open position O and the closed position C, the mixer head 14 can be in a transitory or intermediary position such that the mixer head 14 is rotated upward or downward at an angle of about 11° and about 44° relative to the body 12. However, it is contemplated that the mixer head 14 may be positioned at varying or differing angles as the mixer head 14 transitions between the open position O and the closed position C.

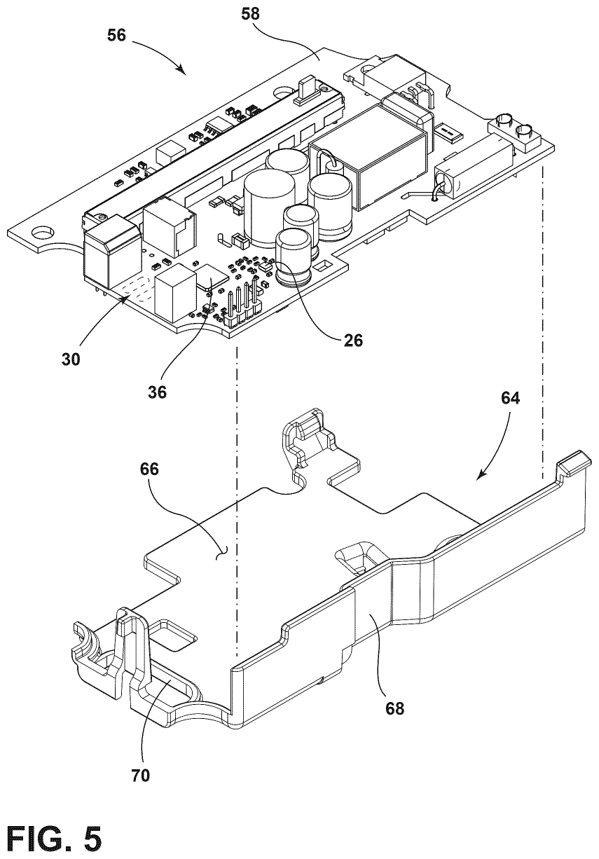

Referring now to FIGS. 1 and 5, an electronic assembly 56 is positioned within the hollow interior 48 of the mixer head 14. The electronic assembly 56 may include a printed circuit board 58, the angular sensor 26, a speed sensor 60, an error sensor 62, the timer 28, the light source 30, and the controller 36. The printed circuit board 58 provides a substrate to facilitate electronic communication between the angular sensor 26, the speed sensor 60, the error sensor 62, the timer 28, the light source 30, and the controller 36. As such, one or more of the aforementioned components of the electronic assembly 56 may be positioned upon the printed circuit board 58. Alternatively, one or more of the aforementioned components may be positioned at other locations within the hollow interior 48 of the mixer head 14, or at other locations of the stand mixer 10. In such a configuration, the aforementioned components not positioned on the printed circuit board 58 may be electronically coupled with the printed circuit board 58 with wiring to facilitate electronic communication. Additionally, as shown in the configuration illustrated in FIG. 5, the speed sensor 60, the error sensor 62, and the timer 28 may be integrated within the controller 36, and/or the controller 36 may be configured to perform the functionalities of the speed sensor 60, the error sensor 62, and/or the timer 28.

Referring still to FIGS. 1 and 5, the printed circuit board 58 is supported within the hollow interior 48 of the mixer head 14 upon a support member 64. The support member 64 forms a substantially planar surface 66 configured to receive and support the printed circuit board 58. The support member 64 forms a support wall 68 that vertically extends substantially perpendicular to the planar surface 66. The support wall 68 may be positioned adjacent to the first side wall 44 or the second side wall 46 of the mixer head 14. The planar surface 66 further forms a support aperture 70 that may be aligned with the light source 30.

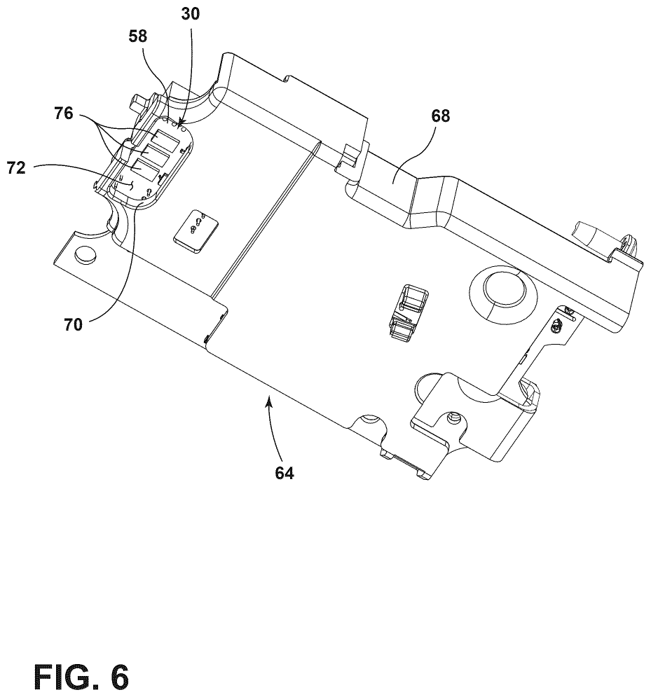

As shown in FIGS. 5 and 6, the light source 30 may be a light emitting diode (LED) array 30 that is positioned on a bottom surface 72 of the printed circuit board 58 to face an interior surface 74 of the bottom side 16 of the mixer head 14. The LED array 30 may be arranged such that each LED 76 of the LED array 30 is positioned to emit light 32 in substantially the same direction, such that the emitted light 32 is substantially directed towards a light aperture 78 formed by the bottom side 16 of the mixer head 14. Alternatively, the light source 30 may be a fiber optic array, wherein a light generator is electronically coupled with the printed circuit board 58 and configured to emit light into a light guide. An emissive end of the light guide may be positioned adjacent to the light aperture 78 and may be configured to emit the generated light in the direction of the light aperture 78.

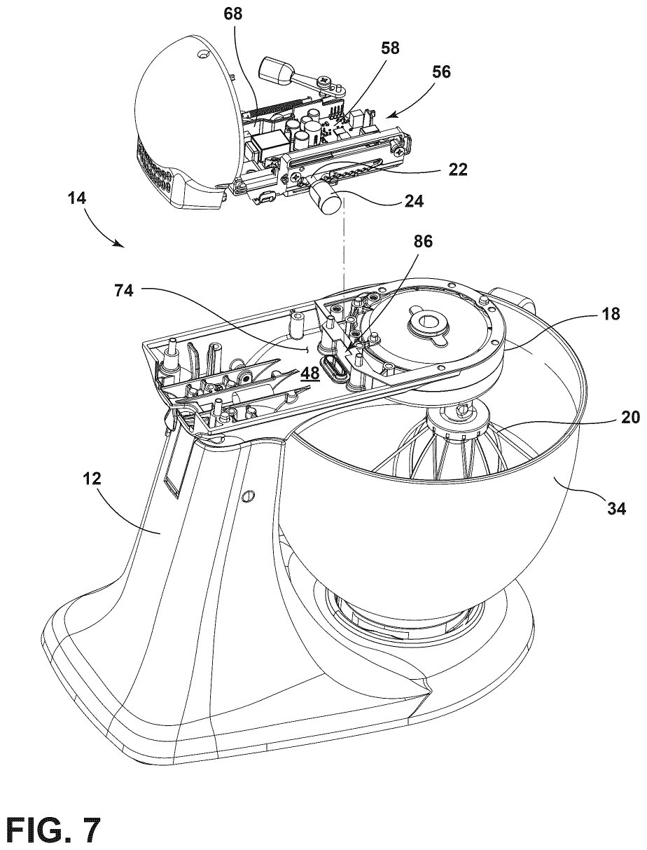

Referring now to FIG. 7, the electronic assembly 56 is coupled with the interior surface 74 of the bottom side 16 of the mixer head 14. Additionally, the electronic assembly 56 is positioned such that the light source 30 is aligned with the light aperture 78, and a lens 86 that is coupled with and partially disposed within the light aperture 78.

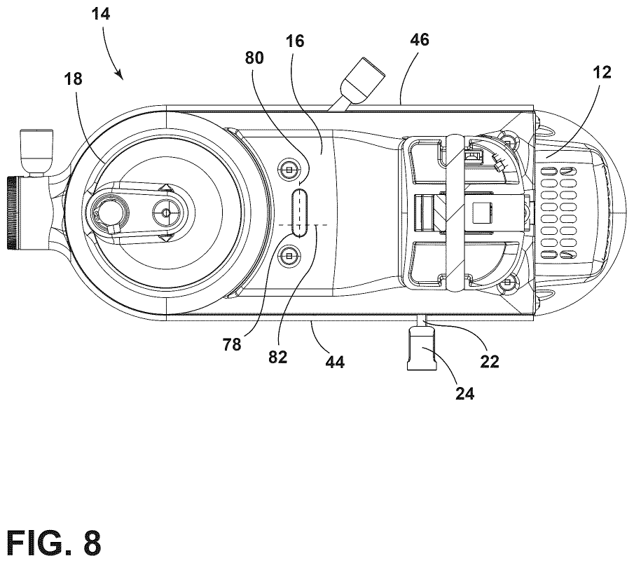

Referring now to FIG. 8, the light aperture 78 is formed by the bottom side 16 of the mixer head 14 and interposed between the attachment portion 18 and the body 12. The light aperture 78 forms a passage to facilitate the transmission of light 32 from the hollow interior 48 of the mixer head 14 to the exterior of the mixer head 14. The light aperture 78 may have a substantially oval shape, wherein a major axis 80 of the light aperture 78 extends towards the first side wall 44 and the second side wall 46, and a minor axis 82 extends towards the attachment portion 18 and the body 12.

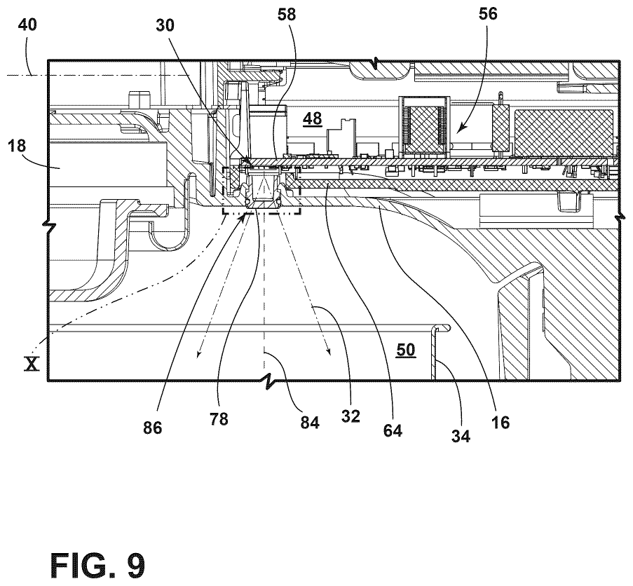

Referring now to FIG. 9, the lens 86 is partially disposed within the light aperture 78. As such, the lens 86 may be positioned adjacent to the light source 30, such that the light 32 emitted from the light source 30 is substantially directed to enter into the lens 86. The lens 86 may be a converging lens with a focal point located at or near the center-point of the interior 50 of the mixing bowl 34. Accordingly, the light 32 passed through the lens 86 may be substantially directed towards the center-point of the interior 50 of the mixing bowl 34. Alternatively, the focal point of the lens 86 may be directed to other locations within the interior 50 of the mixing bowl 34. Additionally, the lens 86 may be treated such that the lens 86 facilitates the diffusion of the light 32 emitted by the light source 30. As such, the light 32 may spread over a substantial majority of the interior 50 of the mixing bowl 34.

Still referring to FIG. 9, the light aperture 78 may be formed such that a longitudinal axis 84 of the light aperture 78 extends substantially perpendicular to the lateral axis 40 of the mixer head 14. Likewise, the lens 86 may be positioned substantially perpendicular relative to the lateral axis 40 of the mixer head 14. The lens 86 may have a substantially oval shape, that may be substantially similar in proportions to the shape of the light aperture 78. Accordingly, a major axis of the lens 86 may extend towards the first side wall 44 and the second side wall 46, and a minor axis may extend between the attachment portion 18 and the body 12.

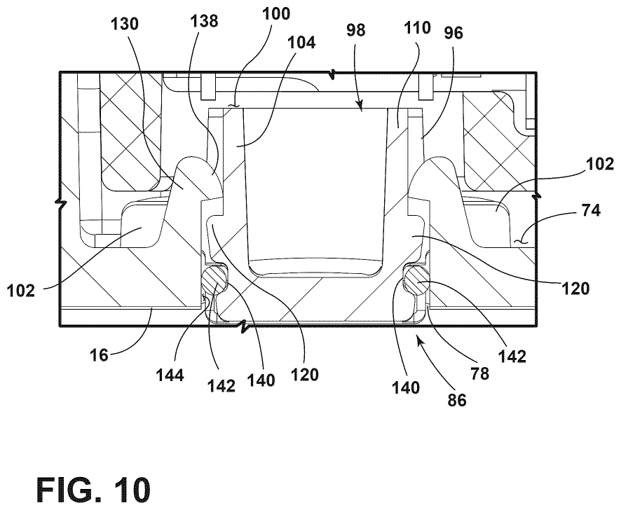

Referring now to FIG. 10, the lens 86 forms a guide wall 96 that circumscribes the perimeter of the lens 86 and vertically extends upwards towards the light source 30. As such, the guide wall 96 may have a substantially oval shape, substantially similar to the shape of the light aperture 78. The guide wall 96 may define an open-ended interior, providing a light guiding space 98 configured to guide light 32 emitted by the light source 30 to the lens 86. A top surface 100 of the guide wall 96 may be in contact with the bottom surface 72 of the printed circuit board 58. Alternatively, the guide wall 96 may be vertically spaced from the bottom surface 72. A substantial majority of the light 32 emitted by the light source 30 may be emitted into the light guiding space 98, retained via the guide wall 96, and directed to emit from the lens 86. As such, the majority of the light 32 emitted by the light source 30 may be captured by the lens 86 and prevented from dissipating within the hollow interior 48 of the mixer head 14. Additionally, the guide wall 96 may extend into the support aperture 70 formed by the planar surface 66 of the support member 64.

Still referring to FIG. 10, the lens 86 forms a lens flange 102 that circumscribes the perimeter of the guide wall 96. The lens flange 102 may annularly extend outwards from the guide wall 96 to support the lens 86 upon the interior surface 74 of the bottom side 16 of the mixer head 14.

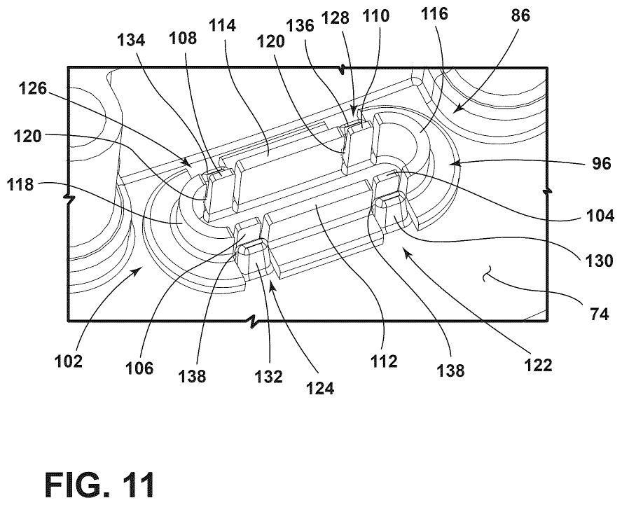

With reference now to FIG. 11, the guide wall 96 forms a first tab 104, a second tab 106, a third tab 108, and a fourth tab 110. Each of the tabs 104, 106, 108, 110 may be configured to deform and pivot relative to the guide wall 96 to facilitate the installation and retention of the lens 86 at the light aperture 78. Accordingly, the guide wall 96 may be segmented, such that the guide wall 96 is formed of a first planar wall 112, a second planar wall 114 opposite the first planar wall 112, a first arcuate wall 116, and a second arcuate wall 118 opposite the first arcuate wall 116. Additionally, each tab 104, 106, 108, 110 may form a prong 120, wherein each prong 120 may face away from a centerline of the lens 86.

The lens flange 102 forms a first slot 122, a second slot 124, a third slot 126, and a fourth slot 128. The first 122, the second 124, the third 126, and the fourth slot 128 are each aligned respectively with the first 104, the second 106, the third 108, and the fourth tab 110. Accordingly, a first retention member 130, a second retention member 132, a third retention member 134, and a fourth retention member 136 formed and vertically extending from the interior surface 74 of the bottom side 16, may be received within each of the slots 122, 124, 126, 128, respectively. The prongs 120 formed by the tabs 104, 106, 108, 110 may interface with the retention members 130, 132, 134, 136 received within the slots 122, 124, 126, 128. Specifically, as the lens 86 is installed, a protrusion 138 formed on each retention member 130, 132, 134, 136 may engage the prongs 120, forcing the tabs 104, 106, 108, 110 to pivot relative to the guide wall 96. As the prongs 120 pass over the protrusions 138, the tabs 104, 106, 108, 110 elastically reform, pivoting back into alignment with the guide wall 96. Accordingly, the lens 86 may be snapped fitted to the interior surface 74 of the bottom side 16 of the mixer head 14.

Referring back to FIG. 10, the lens 86 provides a retention gap 140 formed along the perimeter of the lens 86. The retention gap 140 may provide a space configured to receive a gasket 142. The gasket 142 may be disposed within the retention gap 140 such that the gasket 142 contacts an inner surface 144 of the light aperture 78. Accordingly, the gasket 142 may provide a substantially water-tight seal, preventing fluids splashed out of the mixing bowl 34 from entering into the hollow interior 48 of the mixer head 14 during a mixing operation.

Referring back to FIG. 9, when the light source 30 is activated by the controller 36, the emitted light 32 may be directed, by the combination of the longitudinal axis 84 of the light aperture 78 and the focal point of the lens 86, substantially towards the center-point of the interior 50 of the mixing bowl 34. Alternatively, the combination of the longitudinal axis 84 of the light aperture 78 and the focal point of the lens 86 may direct the emitted light 32 towards a side of the mixing bowl 34, or other locations of the mixing bowl 34 that are off-set from the center-point. In this arrangement, the luminosity of the emitted light 32 may be increased, such that the light 32 has a greater dispersion, allowing the emitted light 32 to brighten a larger portion of the interior 50 of the mixing bowl 34. Additionally, the lens 86 may be configured to diffuse the emitted light 32, such that the light 32 spreads over a greater proportion of the interior 50 of the mixing bowl 34. In sum, the light source 30 may be generally configured to emit light 32 guided to illuminate a substantial majority of the interior 50 of the mixing bowl 34 when the mixer head 14 is in the closed position C. This light 32 may facilitate the use of the stand mixer 10 by at least partially illuminating the interior 50 of the mixing bowl 34 and accordingly, the mixing components held by the mixing bowl 34.

Referring back to FIG. 5, the angular sensor 26 is attached to the printed circuit board 58 and in electronic communication with the controller 36. Alternatively, the angular sensor 26 may be positioned separately from the printed circuit board 58 and disposed elsewhere within the hollow interior 48 of the mixer head 14. The angular sensor 26 is configured to provide sensor data indicative of the position of the mixer head 14 relative to the body 12. In other words, the angular sensor 26 may provide sensor data indicative of whether the mixer head 14 is in the open position O or the closed position C. Additionally, the angular sensor 26 may provide real-time sensor data indicative of a real-time change in the angular position of the mixer head 14 relative to the body 12. The angular sensor 26 may be an accelerometer or may be linked with an accelerometer to provide the controller 36 with data indicating the angular position of the mixer head 14. The angular sensor 26 may be an optical tilt sensor, utilizing fiber Bragg grating technology to detect changes in deflection angles of light emitted by the optical tilt sensor onto a surface of the body 12. The angular sensor 26 may be a ball tilt sensor capable of detecting changes in the angular position of the mixer head 14 relative to the body 12 via changes in the position of a metal ball relative to a circuit of the ball tilt sensor. Further, the angular sensor 26 may be a hall effect sensor, incorporating one or more hall elements to determine the angular position of the mixer head 14 relative to the body 12. The angular sensor 26 may be in electronic communication with the controller 36 via the printed circuit board 58, or through a direct wired connection, to provide the controller 36 with sensor data indicative of the angular position of the mixer head 14 relative to the body 12.

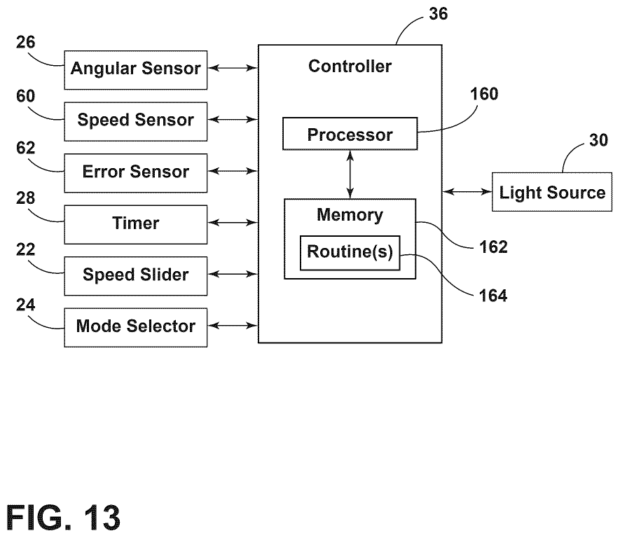

With reference now to FIGS. 5 and 13, the speed sensor 60 may be attached to the printed circuit board 58 and in electronic communication with the controller 36. Alternatively, the speed sensor 60 may be positioned separately from the printed circuit board 58 and disposed elsewhere within the hollow interior 48 of the mixer head 14. The speed sensor 60 may be configured to provide sensor data indicative of the rotational velocity of the mixing attachment 20. The speed sensor 60 may be in electronic communication with the controller 36 via the printed circuit board 58, or through a direct wired connection, to provide the controller 36 with sensor data indicative of the rotational velocity of the mixing attachment 20. Alternatively, as illustrated in FIG. 5, the speed sensor 60 may be integrated within the controller 36, or the controller 36 may provide a dedicated unit configured to function as the speed sensor 60.

With continued reference to FIGS. 5 and 13, the error sensor 62 may be attached to the printed circuit board 58 and in electronic communication with the controller 36. Alternatively, the error sensor 62 may be positioned separately from the printed circuit board 58 and disposed elsewhere within the hollow interior 48 of the mixer head 14. The error sensor 62 may be in electronic communication with the angular sensor 26 and the speed sensor 60, such that the error sensor 62 can monitor the sensor data provided by the angular sensor 26 and the speed sensor 60. Alternatively, as illustrated in FIG. 5, the error sensor 62 may be integrated within the controller 36, or the controller 36 may provide a dedicated unit configured to function as the error sensor 62. The error sensor 62 may be configured to provide sensor data indicative of an error in the operation of the stand mixer 10. An error in the operation of the stand mixer 10 may occur when either the angular sensor 26 or the speed sensor 60 provides sensor data to the error sensor 62 indicating a deviation from an acceptable operational parameter. An acceptable operational parameter defines a threshold beyond which the stand mixer 10 is determined to be in an unacceptable operating state. Deviations from an acceptable operational parameter may correspond to a risk of damage to the stand mixer 10. Examples of acceptable operational parameters include, but are not limited to, a maximum rotational velocity of the mixing attachment 20, an average acceleration and deacceleration of the mixing attachment 20, indicative of an unobstructed rotation of the mixing attachment 20, and an average deacceleration as the mixer head 14 moves between the open position O and the closed position C, indicative of an unobstructed transition between the two positions. Accordingly, the error sensor 62 may produce sensor data indicative of an error in the operation of the stand mixer 10 when the mixing attachment 20 rotates at a rotational velocity above a predetermined threshold, the rotation of the mixing attachment 20 is hindered due to an obstruction, or when an obstruction hinders the transitioning of the mixer head 14 between the open position O and the closed position C. In sum, the error sensor 62 may be in electronic communication with the controller 36 and configured to produce sensor data indicative of an error in the operation of the stand mixer 10. Alternatively, as illustrated in FIG. 5, the controller 36 may be configured to perform all functionalities of the error sensor 62.

Still referring to FIGS. 5 and 13, the timer 28 may be attached to the printed circuit board 58 and in electronic communication with the controller 36. Alternatively, the timer 28 may be positioned separately from the printed circuit board 58 and disposed elsewhere within the hollow interior 48 of the mixer head 14. Alternatively, in the illustrated configuration shown in FIG. 5, the timer 28 may be an internal timer, integrated within the controller 36, or the controller 36 may be configured to perform all functionalities of the timer 28. The timer 28 is configured to produce and communicate timing data to the controller 36, such that the controller 36 may provide time-based functionalities to the stand mixer 10

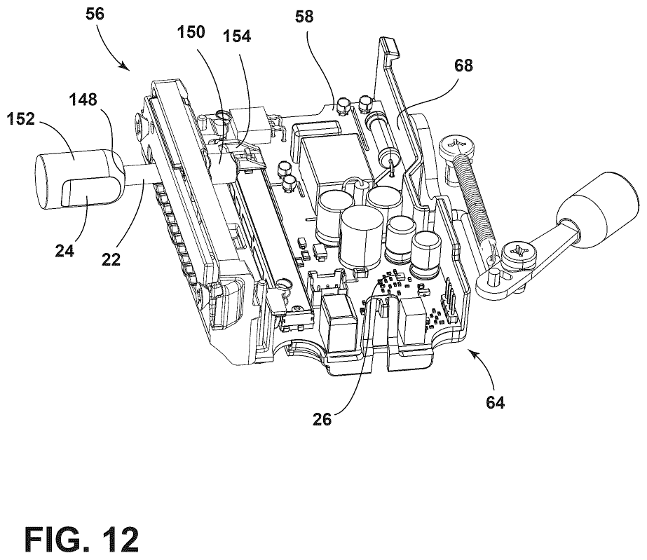

Referring now to FIG. 12, the speed slider 22 is slidably interposed within a slot 146 formed in the first side wall 44 as illustrated in FIG. 2, or alternatively, formed in the second side wall 46. The speed slider 22 may have a first end 148 and a second end 150, wherein the first end 148 is provided with a knob 152 and the second end 150 is provided with a speed actuator 154 configured to interface with the printed circuit board 58. As such, the first end 148 and the knob 152 may be disposed at the exterior of the first side wall 44 or alternatively, the second side wall 46, and the second end 150 and the speed actuator 154 may be disposed within the hollow interior 48 of the mixer head 14. The speed actuator 154 may be in electronic communication with the controller 36 via conductors disposed on the speed actuator 154 that may interface with conductors provided on the printed circuit board 58. As such, the user may control the rotational velocity of the mixing attachment 20 through translating the speed actuator 154 via the knob 152 across the conductors formed on the printed circuit board 58. The speed actuator 154 may be in electronic communication with the controller 36 via the conductors positioned on the printed circuit board 58, such that the controller 36 is capable of tracking the position of the speed actuator 154. Accordingly, the controller 36 may be configured to monitor the rotational velocity of the mixing attachment 20 set by the user via the speed slider 22.

Referring still to FIG. 12, the mode selector 24 is provided to the stand mixer 10 to allow the user to control the operational mode of the stand mixer 10. As shown in FIG. 12, the mode selector 24 may be the knob 152 of the speed slider 22. The knob 152 may be configured to rotate about a lateral axis of the speed slider 22 to allow the user to select the operational mode of the stand mixer 10. A mode actuator may be disposed on the second end 150 of the speed slider 22. The mode actuator may provide conductors that may be configured to selectively interact, in accordance with a rotation of the knob 152, with conductors provided on the printed circuit board 58. The interaction between the mode actuator and the conductors of the printed circuit board 58 may facilitate the selection of the operational mode of the stand mixer 10 by the user. Alternatively, the mode selector 24 may be a lever, a button, or a slider operationally similar to the speed slider 22. The mode selector 24 may be positioned at other locations of the stand mixer 10, such as the base 38 or the body 12 of the stand mixer 10.

Referring again to FIGS. 5 and 13, the controller 36 is attached to the printed circuit board 58 and in electronic communication with the aforementioned sensors 26, 60, 62, the timer 28, the speed slider 22, and the mode selector 24. Alternatively, the controller 36 may be positioned separately from the printed circuit board 58 and disposed elsewhere within the hollow interior 48 of the mixer head 14. The controller 36 may be configured to control the operation of the light source 30 in response to sensor data provided to the controller 36 by the aforementioned sensors 26, 60, 62. Additionally, the controller 36 may be configured to determine the operation of the light source 30 in response to timing data provided to the controller 36 by the timer 28. Further, the controller 36 may be configured to control the light source 30 in response to a user interaction with either the speed slider 22 or the mode selector 24. As an alternative to the use of the controller 36, each of the aforementioned sensors 26, 60, 62, the timer 28, the speed slider 22, and/or the mode selector 24 may be in direct electronic communication with the light source 30. In such a configuration, an electrical current may be provided to activate the light source 30 when either of the aforementioned sensors 26, 60, 62 detects that the mixer head 14 is in the closed position C, the rotational velocity of the mixing attachment 20 is greater than 0 rad/s, and/or an error has occurred in the operation of the stand mixer 10. Further, an electrical current may be provided to activate the light source 30 when the user interacts with the speed slider 22 and/or the mode selector 24.

Referring to FIG. 13, the controller 36 may have a processor 160, a memory 162, and other control circuitry. Instructions or routines 164 may be stored in the memory 162 and executable by the processor 160. The instructions 164 may generally relate to the operation of the stand mixer 10, and specifically, may relate to the functionalities of the light source 30. The angular sensor 26, the speed sensor 60, and the error sensor 62 may be in electronic communication with the controller 36 to provide the controller 36 with sensor data. Alternatively, one or more of the aforementioned sensors 26, 60, 62 may be incorporated with the controller 36 or the controller 36 may be configured to function as one or more of the aforementioned sensors 26, 60, 62. The timer 28 may be in electronic communication with the controller 36 to provide the controller 36 with timing data. Alternatively, the timer 28 may be incorporated with the controller 36, or the controller 36 may be configured to function as the timer 28. The speed slider 22 and the mode selector 24 may be in electronic communication with the controller 36 to provide the controller 36 with data indicating the set rotational velocity of the mixing attachment 20 and the set mode of the stand mixer 10.

The controller 36 may be configured to control the light source 30 through the execution of one or more of the routines 164 stored in the memory 162. The controller 36 may be configured to activate the light source 30, deactivate the light source 30, and adjust the intensity of the light 32 produced by the light source 30. As illustrated in FIG. 12, the controller 36 may be a microcontroller. Alternatively, or in addition to the controller 36, an electronic circuit may interlink the angular sensor 26 and the light source 30, wherein the angular sensor 26 may be configured to provide an electrical output to the electronic circuit to activate the light source 30 when the mixer head 14 is in the closed position C.

The controller 36 may be configured to activate the light source 30 to produce light 32 substantially towards the interior 50 of the mixing bowl 34 when the angular sensor 26 produces sensor data indicating that the mixer head 14 is in the closed position C (FIG. 4B). The controller 36 may be configured to deactivate the light source 30 when the angular sensor 26 produces sensor data indicating that the mixer head 14 is in the open position O (FIG. 4A). Additionally, the controller 36 may be configured to control the light source 30 such that the intensity of the light 32 emitted by the light source 30 scales in relation to the angular position of the mixer head 14, as the mixer head 14 transitions between the open position O and the closed position C. As such, the controller 36 may be configured to control the light source 30 to gradually brighten, as the mixer head 14 is tilted from the open position O to the closed position C. Likewise, the controller 36 may be configured to control the light source 30 to gradually dim, as the mixer head 14 is tilted from the closed position C to the open position O.

The controller 36 may be configured to control the light source 30 in response to sensor data produced by the angular sensor 26 in conjunction with timing data produced by the timer 28. The controller 36 may be configured to activate and monitor the timer when the controller 36 is provided with data indicating a change in the angular position of the mixer head 14. As such, the controller 36 may be configured to activate and monitor the timer 28 when the controller 36 is provided with data indicating that the mixer head 14 is in the closed position C. The controller 36 may then activate the light source 30 and gradually increase the intensity of the light 32 emitted by the light source 30 over a brightening period as measured by the timer 28. The light source 30 may be controlled by the controller 36 to reach a maximum intensity or a maximum brightness that the light source 30 can produce, by the time the timer 28 has been active for the period of time defined by the brightening period. The brightening period may be a span of time of about 0.5 seconds to about 2 seconds and the aforementioned values may be stored within the memory 162 of the controller 36. Accordingly, when the mixer head 14 is tilted to the closed position C, the light source 30 may gradually increase in brightness over a period of time specified by the brightening period to the maximum brightness. This functionality provides a slight delay, as perceived by the user, in the activation of the light source 30, avoiding a harsh transition to the maximum brightness. As such, the aesthetic qualities of the stand mixer 10 may be improved.

The controller 36 may be configured to activate the light source 30 when the speed sensor 60 provides sensor data to the controller 36 indicating an increase in the rotational velocity of the mixing attachment 20. Additionally, the controller 36 may be configured to control the light source 30 such that the brightness of the light source 30 indicates the rotational velocity of the mixing attachment 20. The light source 30 may be controlled to increase or decrease the brightness of the emitted light 32 to correspond in real-time to increases or decreases in the rotational velocity of the mixing attachment 20. For example, as the rotational velocity of the mixing attachment 20 increases, the controller 36 may increase the brightness of the emitted light 32 in parallel with the increasing rotational velocity. Likewise, as the rotational velocity of the mixing attachment 20 decreases, the controller 36 may decrease the brightness of the emitted light 32 in parallel with the decreasing rotational velocity. As such, the controller 36 may control the light source 30, such that the brightness of the emitted light 32 indicates the rotational velocity of the mixing attachment 20.

The controller 36 may be configured to activate the light source 30 when the error sensor 62 provides sensor data to the controller 36 indicating an error in the operation of the stand mixer 10. Specifically, the controller 36 may be configured to control the light source 30 such that the light source 30 provides a strobe effect when the error sensor 62 provides sensor data indicating an error. When the light source 30 is controlled by the controller 36 to produce a strobe effect, the light source 30 may provide intermittently timed flashes of light 32. As such, when an error occurs in the operation of the stand mixer 10, the light source 30 may be controlled to produce a strobe effect, alerting the user of the stand mixer 10 of the occurrence of an error.

The controller 36 may be configured to activate the light source 30 when the controller 36 detects a user interaction with the speed slider 22. Specifically, the controller 36 may be configured to activate the light source 30 when the controller 36 detects that the user has translated the speed actuator 154 across the printed circuit board 58, changing the set rotational velocity of the mixing attachment 20. However, a user interaction may occur whenever the user moves, turns, or touches the speed slider 22.

The controller 36 may be configured to control the light source 30 in response to sensor data from the angular sensor 26 in conjunction with a detection of a user interaction with the speed slider 22. Specifically, the controller 36 may be configured to activate the light source 30 and adjust the emitted light 32 to a maximum brightness when the controller 36 detects a user interaction with the speed slider 22 and is provided with sensor data from the angular sensor 26 indicating that the mixer head 14 is in the closed position C. The controller 36 may be configured to activate the light source 30 and adjust the brightness of the emitted light 32 to a dimmed brightness when the controller 36 detects a user interaction with the speed slider 22 and is provided with sensor data from the angular sensor 26 indicating that the mixer head 14 is in the open position O. The dimmed brightness may be a brightness about half as bright as the maximum brightness that the light source 30 can produce.

The controller 36 may be configured to control the light source 30 in response to a user interaction with the speed slider 22 in conjunction with timing data produced by the timer 28. The controller 36 may be configured to activate and monitor the timer 28 when the controller 36 detects a user interaction with the speed slider 22. As such, the controller 36 may be configured to provide a delayed activation of the light source 30, wherein the controller 36 activates the light source 30 once the timer 28 has been active for a period of time greater than a first interaction delay period. The first interaction delay period may be a span of time of about 0.1 second to about 1 second and the aforementioned values may be stored within the memory 162 of the controller 36. Accordingly, when a user interaction with the speed slider 22 is detected by the controller 36, the light source 30 may be activated after the passage of the first interaction delay period, resulting in a delay between the user interaction with the speed slider 22 and the activation of the light source 30. In operation, when the controller 36 detects a user interaction with the speed slider 22, the controller 36 may activate and begin monitoring the timer 28. Once the controller 36 detects that the timer 28 has been active for a period of time greater than the first interaction delay period, the controller 36 may activate the light source 30.

The controller 36 may be configured to activate the light source 30 when the controller 36 detects a user interaction with the mode selector 24. Specifically, the controller 36 may be configured to activate the light source 30 when the user has rotated the mode selector 24 to select the operational mode of the stand mixer 10. However, a user interaction may be detected whenever the user moves, turns, or touches the mode selector 24.

The controller 36 may be configured to control the light source 30 in response to a user interaction with the mode selector 24 in conjunction with timing data produced by the timer 28. The controller 36 may be configured to activate and monitor the timer 28 when the controller 36 detects a user interaction with the mode selector 24. As such, the controller 36 may be configured to provide a delayed activation of the light source 30, wherein the controller 36 activates the light source 30 once the timer 28 has been active for a period of time greater than a second interaction delay period. Accordingly, when a user interaction with the mode selector 24 is detected by the controller 36, the light source 30 may be activated after the passage of a second interaction delay period, resulting in a delay between the user interaction with the mode selector 24 and the activation of the light source 30. The second interaction delay period may be a span of time of about 0.1 second to about 1 second and the aforementioned values may be stored within the memory 162 of the controller 36. In operation, when the controller 36 detects a user interaction with the mode selector 24, the controller 36 may activate and begin monitoring the timer 28. Once the controller 36 detects that the timer 28 has been active for a period of time greater than the second interaction delay period, the controller 36 may activate the light source 30.

The controller 36 may be configured to control the light source 30 to deactivate when the controller 36 detects that the timer 28 has been active for a period of time greater than a timeout period. As mentioned above, the controller 36 is configured to activate and monitor the timer 28 when the controller 36 detects that a user has interacted with either the speed slider 22 or the mode selector 24 or that the angular sensor 26 has provided sensor data indicating a change in the angular position of the mixer head 14. The timeout period may be a period of time between about 3 minutes and about 7 minutes and the aforementioned values may be stored within the memory 162. Additionally, the controller 36 may be configured to reset the timer 28 when the controller 36 detects a subsequent interaction with either the speed slider 22 or the mode selector 24, or that the angular sensor 26 has provided sensor data indicating a change in the angular position of the mixer head 14. As such, the timer 28 may be reset when the user interacts with either the speed slider 22 or the mode selector 24 or alters the angular position of the mixer head 14.

The controller 36 may be further configured to delay the start of the timeout period when the speed sensor 60 provides sensor data to the controller 36 indicating that the mixing attachment 20 is currently in operation, i.e., has a rotational velocity greater than 0 rad/s. In such circumstances, the controller 36 may not begin monitoring the timer 28 with respect to the timeout period until the speed sensor 60 provides sensor data indicating that the mixing attachment 20 is no longer rotating.

In operation, the controller 36 will activate and begin monitoring the timer 28 when the user interacts with the stand mixer 10 through interacting with the speed slider 22, interacting with the mode selector 24, or adjusting the angular position of the mixer head 14. If the user makes a subsequent interaction with the stand mixer 10, the controller 36 will reset the timer 28. If the controller 36 detects that the mixing attachment 20 is in use, the controller 36 will delay monitoring the timer 28 with respect to the timeout period, until the mixing attachment 20 is no longer in use. When the controller 36 detects that the timer 28 has been active for a sequential period of time greater than the timeout period, the controller 36 may deactivate the light source 30. This functionality may prevent an unnecessary expenditure of energy, deactivating the light source 30 when the controller 36 has determined that the stand mixer 10 is not presently in use by the user.

The controller 36 may be configured to control the light source 30 to provide a faded deactivation when the controller 36 detects that the timer 28 has been active for a sequential period of time greater than the timeout period. Specifically, the controller 36 may reset and monitor the timer 28 when the controller 36 detects that the timer 28 has been active for a period of time greater than the timeout period. The controller 36 may then control the light source 30 to gradually decrease the intensity of light 32 emitted by the light source 30 over a period of time defined by a dimming period. The controller 36 may then deactivate the light source 30 when the controller 36 detects that the timer 28 has been active for a period of time greater than the dimming period. The dimming period may be a span of time of about 1.5 seconds to about 3.5 seconds and the aforementioned values may be stored within the memory 162.

The controller 36 may be configured to reset the timer 28 if the user interacts with either the speed slider 22, the mode selector 24, or adjusts the angular position of the mixer head 14 before the timer 28 has been active for a period of time greater than the dimming period. Accordingly, the user may prevent the time-out of the light source 30 through interacting with the stand mixer 10 during the dimming period.

In operation, once the controller 36 determines that the user has not interacted with the stand mixer 10 for a sequential period of time greater than the timeout period, the controller 36 will reset and monitor the timer 28. The controller 36 will gradually dim the light source 30, alerting the user that the light source 30 may soon deactivate. The user may then interact with the stand mixer 10 to reset the timer 28. Alternatively, the timer 28 will remain active for a sequential period of time greater than the dimming period and the light source 30 will gradually decrease in intensity until it is ultimately deactivated at the end of the dimming period.

Use of the present assembly may provide for a variety of advantages. For example, the light source 30 may help to illuminate the contents of the mixing bowl 34 while the user is combining cooking ingredients. Additionally, the activation and deactivation of the light source 30 in accordance with the angular position of the mixer head 14 may facilitate ease of use, as the user may no longer be required to manually activate the light source 30 when the mixer head 14 is in the closed position C. The timed functionalities of the present assembly may further facilitate the use of the stand mixer 10. The timeout functionality ensures that the light source 30 remains active when the stand mixer 10 is in use, but deactivates upon a determination that the user is no longer using the stand mixer 10. As such, the user is relieved of having to manually turn off the light source 30 when they have finished using the stand mixer 10. Additionally, the error alert functionality may improve the longevity of the stand mixer 10, as the user is alerted to possibly deleterious operational errors while using the stand mixer 10.

The device disclosed herein is further summarized in the following paragraphs and is further characterized by combinations of any and all of the various aspects described therein.

According to one aspect of the present disclosure, a stand mixer includes a body and a mixer head pivotably coupled to the body. The mixer head is configured to pivot between an open position and a closed position. An attachment portion is coupled to a bottom side of the mixer head. An angular sensor is coupled with the mixer head and configured to produce sensor data indicative of the angular position of the mixer head relative to the body. A light source is coupled with the bottom side of the mixer head and interposed between the body and attachment portion. A controller is in electronic communication with the angular sensor and the light source. The controller is configured to control the light source in response to the sensor data produced by the angular sensor.

According to another aspect, the controller is configured to control the light source by activating the light source when the mixer head is in the closed position.

According to another aspect, the controller is configured to control the light source by deactivating the light source when the mixer head is in the open position.

According to another aspect, the controller is configured to control the light source by activating the light source and gradually increasing the intensity of the light emitted by the light source as the mixer head is pivoted from the open position to the closed position.

According to another aspect, the controller is further configured to control the light source by gradually decreasing the intensity of the light emitted by the light source as the mixer head is pivoted from the closed position to the open position.

According to yet another aspect, a stand mixer includes a body and a mixer head pivotably coupled to the body. An attachment portion is coupled to a bottom side of the mixer head. A sensor is coupled with the mixer head that produces sensor data. A light source is coupled with the bottom side of the mixer head and interposed between the body and the attachment portion. A controller is in communication with the sensor and the light source, wherein the controller controls the light source in response to the sensor data produced by the sensor.

According to another aspect, the sensor is an angular sensor configured to produce sensor data indicative of the angular position of the mixer head relative to the body.

According to another aspect, the sensor is a speed sensor configured to produce sensor data indicative of a rotational velocity of a mixing attachment coupled with the attachment portion.

According to another aspect, the sensor is an error sensor configured to produce sensor data indicative of the occurrence of an error in the operation of the stand mixer.

According to another aspect, the controller controls the light source by activating the light source in response to an increase in the rotational velocity of the mixing attachment.

According to another aspect, the controller controls the light source to provide a strobe effect in response to the occurrence of an error in the operation of the stand mixer.

According to yet another aspect, a stand mixer includes a body and a mixer head pivotably coupled to the body. An attachment portion is coupled to a bottom side of the mixer head. A mixing attachment is coupled with the attachment portion. A speed slider is operably coupled with the mixer head and is configured to be operable by a user to control a rotational velocity of the mixing attachment. A mode selector is operably coupled with the mixer head and is configured to be operable by a user to select an operational mode of the stand mixer. An angular sensor is operably coupled with the mixer head and is configured to produce sensor data indicative of the angular position of the mixer head relative to the body. A timer is operably coupled with the mixer head. A light source is operably coupled with the bottom side of the mixer head and interposed between the body and the attachment portion. A controller is in communication with the speed slider, the mode selector, the angular sensor, the timer, and the light source. The controller is configured to control the light source in response to the sensor data produced by the angular sensor.

According to another aspect, the controller is further configured to control the light source in response to a user interaction with the speed slider.

According to another aspect, the controller is further configured to control the light source in response to a user interaction with the mode selector.

According to another aspect, the controller is further configured to activate and monitor the timer in response to a change in the angular position of the mixer head relative to the body.

According to another aspect, the controller is further configured to deactivate the light source when the timer has been active for a period of time greater than a timeout period.

According to another aspect, the controller is further configured to reset and monitor the timer when the timer has been active for a period of time greater than the timeout period, decrease an intensity of the light emitted from the light source gradually over a dimming period, and deactivate the light source when the timer has been active for a period of time greater than the dimming period.

According to another aspect, the controller is further configured to activate and gradually increase the intensity of the light emitted by the light source over a brightening period.

According to another aspect, the controller is further configured to increase the intensity of the light emitted by the light source to a maximum intensity over the brightening period.

According to another aspect, the controller is configured to control the light source to emit a dimmed light in response to a user interaction with the mode selector.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A stand mixer, comprising:
a body;
a mixer head pivotably coupled to the body and configured to pivot between an open position and a closed position;
an attachment portion coupled to a bottom side of the mixer head;
an angular sensor coupled with the mixer head and configured to produce sensor data indicative of the angular position of the mixer head relative to the body;
a light source coupled with the bottom side of the mixer head and interposed between the body and the attachment portion; and
a controller in communication with the angular sensor and the light source, wherein the controller is configured to control the light source in response to the sensor data produced by the angular sensor.

2. The stand mixer of claim 1, wherein the controller is configured to control the light source by activating the light source when the mixer head is in the closed position.

3. The stand mixer of claim 1, wherein the controller is configured to control the light source by deactivating the light source when the mixer head is in the open position.

4. The stand mixer of claim 1, wherein the controller is configured to control the light source by activating the light source and gradually increasing the intensity of the light emitted by the light source as the mixer head is pivoted from the open position to the closed position.

5. The stand mixer of claim 1, wherein the controller is further configured to control the light source by gradually decreasing the intensity of the light emitted by the light source as the mixer head is pivoted from the closed position to the open position.

6. A stand mixer, comprising:
a body;
a mixer head pivotably coupled to the body;
an attachment portion coupled to a bottom side of the mixer head;
a sensor coupled with the mixer head that produces sensor data;
a light source coupled with the bottom side of the mixer head and interposed between the body and the attachment portion; and
a controller in communication with the sensor and the light source, wherein the controller controls the light source in response to the sensor data produced by the sensor.

7. The stand mixer of claim 6, wherein the sensor is an angular sensor that produces sensor data indicative of the angular position of the mixer head relative to the body.

8. The stand mixer of claim 6, wherein the sensor is a speed sensor that produces sensor data indicative of a rotational velocity of a mixing attachment coupled with the attachment portion.

9. The stand mixer of claim 6, wherein the sensor is an error sensor that produces sensor data indicative of the occurrence of an error in the operation of said stand mixer.

10. The stand mixer of claim 8, wherein the controller controls the light source by activating the light source in response to an increase in the rotational velocity of the mixing attachment.

11. The stand mixer of claim 9, wherein the controller controls the light source to provide a strobe effect in response to the occurrence of an error in the operation of said stand mixer.

12. A stand mixer, comprising:
a body;
a mixer head pivotably coupled to the body;
an attachment portion coupled to a bottom side of the mixer head;
a mixing attachment coupled with the attachment portion;
a speed slider operatively coupled with the mixer head, configured to be operable by a user to control a rotational velocity of the mixing attachment;
a mode selector operatively coupled with the mixer head, configured to be operable by a user to select an operational mode of said stand mixer;
an angular sensor operatively coupled with the mixer head, configured to produce sensor data indicative of the angular position of the mixer head relative to the body;
a timer operatively coupled with the mixer head;
a light source operatively coupled with the bottom side of the mixer head and interposed between the body and the attachment portion; and
a controller in communication with the speed slider, the mode selector, the angular sensor, the timer, and the light source, wherein the controller is configured to control the light source in response to the sensor data produced by the angular sensor.

13. The stand mixer of claim 12, wherein the controller is further configured to control the light source in response to a user interaction with the speed slider.

14. The stand mixer of claim 12, wherein the controller is further configured to control the light source in response to a user interaction with the mode selector.

15. The stand mixer of claim 12, wherein the controller is further configured to activate and monitor the timer in response to a change in the angular position of the mixer head relative to the body.

16. The stand mixer of claim 15, wherein the controller is further configured to deactivate the light source when the timer has been active for a period of time greater than a timeout period.

17. The stand mixer of claim 15, wherein the controller is further configured to reset and monitor the timer when the timer has been active for a period of time greater than a timeout period, decrease an intensity of the light emitted from the light source gradually over a dimming period, and deactivate the light source when the timer has been active for a period of time greater than the dimming period.

18. The stand mixer of claim 15, wherein the controller is further configured to activate and gradually increase the intensity of the light emitted by the light source over a brightening period.

19. The stand mixer of claim 18, wherein the controller is further configured to increase the intensity of the light emitted by the light source to a maximum intensity over the brightening period.

20. The stand mixer of claim 14, wherein the controller is configured to control the light source to emit a dimmed light in response to the user interaction with the mode selector.
